(19) United States
(12) Patent Application Publication
(10) Pub. No.: US 2018/0321047 A1
(43) Pub. Date: Nov. 8, 2018

(54) VEHICULAR DOWNLOAD CONTROL DEVICE AND DOWNLOAD CONTROL METHOD

(71) Applicant: DENSO CORPORATION, Kariya-city, Aichi-pref. (JP)

(72) Inventor: Daisuke SAGAWA, Kariya-city (JP)

(21) Appl. No.: 15/772,944

(22) PCT Filed: Oct. 11, 2016
(86) PCT No.: PCT/JP2016/080054

§ 371 Date: May 2, 2018

(30) Foreign Application Priority Data
Nov. 4, 2015 (JP) 2015-216856

(51) Int. Cl. G01C 21/34; G06F 8/65; G06F 17/30; H04W 4/40; H04L 29/08

(52) U.S. Cl. CPC G01C 21/3407; G06F 8/65; H04L 67/34; H04W 4/40; G06F 17/30241

(57) ABSTRACT

A vehicular download control device, which is mounted on a vehicle having a function of acquiring a current position and a function of acquiring a travel route to a destination, and controls an operation of download of data from an outside, includes: a travel route acquiring unit; a travel route dividing unit that divides the travel route into an unsuitable section and a suitable section suitable for the download; a required time acquiring unit that acquires a required time for the download of the data; a starting point setting unit that sets a starting point of the download of the data on the travel route based on a result of division of the travel route and the required time; and a download starting unit that starts the download of the data when the vehicle arrives at the starting point.

### CROSS REFERENCE TO RELATED APPLICATION

This application is based on Japanese Patent Application No. 2015-216856 filed on Nov. 4, 2015, the disclosure of which is incorporated herein by reference.

### TECHNICAL FIELD

The present disclosure relates to a vehicular download control device and a download control method for acquiring data using wireless communication in a traveling vehicle.

### BACKGROUND ART

Various pieces of software (that is, various programs and data referred to by the programs) are mounted on vehicles of today. Various functions are implemented by these various pieces of software. Further, it is possible to improve a function or add a new function by updating software.

Further, the update of software can be executed by downloading necessary update data through wireless communication.

However, when the size of update data increases, a time required for the download becomes longer, which increases a possibility of failure of the download. When the download ends in failure, it is required to perform the download again. Thus, a time and a communication cost required for update increase, which puts a load on a user.

Thus, there has been proposed a technique that interrupts and restarts download of update data according to a state of a vehicle (e.g., a state of a brake for braking or a vehicle speed) (Patent Literature 1).

However, the above proposed technique still has a problem in that it is not possible to reduce the load on a user caused by increases in the time and the communication cost required for update.

This is because of the following reason. First, the proposed technique may cause a situation in which an interruption and a restart of download are repeated according to a state of the vehicle. Further, when such a situation occurs, the download takes long time due to the repeated interruptions of the download, which increases the time required for the download. Further, when the download is interrupted, a communication occurs between the vehicle and a server. Further, also when the download is restarted, a communication occurs between the vehicle and the server. Thus, a communication amount increases by these communications with the server.

Due to the above reasons, in the proposed technique, the time and the communication load required for the update increase even when the download does not end in failure.

### PRIOR ART LITERATURES

### Patent Literature

Patent Literature 1: JP-2012-103181-A

### SUMMARY OF INVENTION

It is an object of the present disclosure to provide a vehicular download control device and a download control method that make it possible to reduce a time and a communication cost required for download in a vehicle to reduce the load on a user.

According to a first aspect of the present disclosure, a vehicular download control device, which is mounted on a vehicle having a function of acquiring a current position and a function of acquiring a travel route to a set destination, and controls an operation of download of data from an outside of the vehicle, includes: a travel route acquiring unit that acquires the travel route of the vehicle; a travel route dividing unit that divides the travel route into an unsuitable section unsuitable for the download and a suitable section suitable for the download based on an attribute of a point where the travel route passes; a required time acquiring unit that acquires a required time required for the download of the data; a starting point setting unit that sets a starting point of the download of the data on the travel route based on a result of division of the travel route and the required time; and a download starting unit that detects an arrival of the vehicle at the starting point and starts the download of the data.

In the above vehicular download control device, the download can be completed during a travel in the suitable section suitable for download by appropriately setting the starting point of the download. Thus, it is possible to prevent a failure and a retry of the download or repetition of the interruption and restart of the download. Therefore, it is possible to reduce the load on a user in view of the time and the communication cost required for the download.

According to a second aspect of the present disclosure, a download control method, for a vehicle having a function of acquiring a current position and a function of acquiring a travel route to a set destination, for controlling an operation of download of data from an outside of the vehicle, includes: acquiring the travel route of the vehicle; dividing the travel route into an unsuitable section unsuitable for the download and a suitable section suitable for the download based on an attribute of a point where the travel route passes; acquiring a required time required for the download of the data; setting a starting point of the download of the data on the travel route based on a result of division of the travel route and the required time; and detecting an arrival of the vehicle at the starting point, and starting the download of the data.

In the above download control method, the download can be completed during a travel in the suitable section suitable for download by appropriately setting the starting point of the download. Thus, it is possible to prevent a failure and a retry of the download or repetition of the interruption and restart of the download. Therefore, it is possible to reduce the load on a user in view of the time and the communication cost required for the download.

### BRIEF DESCRIPTION OF DRAWINGS

The above and other objects, features and advantages of the present disclosure will become more apparent from the following detailed description made with reference to the accompanying drawings. In the drawings:

FIGS. 1A and 1B are explanatory diagrams illustrating a general structure of a download device 10 according to the present embodiment;

FIG. 2 is a flowchart of a download process which is executed inside the download device 10;

FIG. 3 is a flowchart of a download starting point setting process;

FIG. 4 is an explanatory diagram illustrating a state of the comparison between the length of each suitable section and a required time for the download;

FIG. 5 is a flowchart of a download execution process;

FIGS. 6A and 6B are explanatory diagrams schematically illustrating a state in which update data is downloaded by the download process; and

FIG. 7 is a flowchart of a download starting point setting process according to a modification.

### EMBODIMENTS FOR CARRYING OUT INVENTION

Hereinbelow, an embodiment will be described for clarifying details of the invention of the present application described above.

### A: Device Configuration of the Present Embodiment

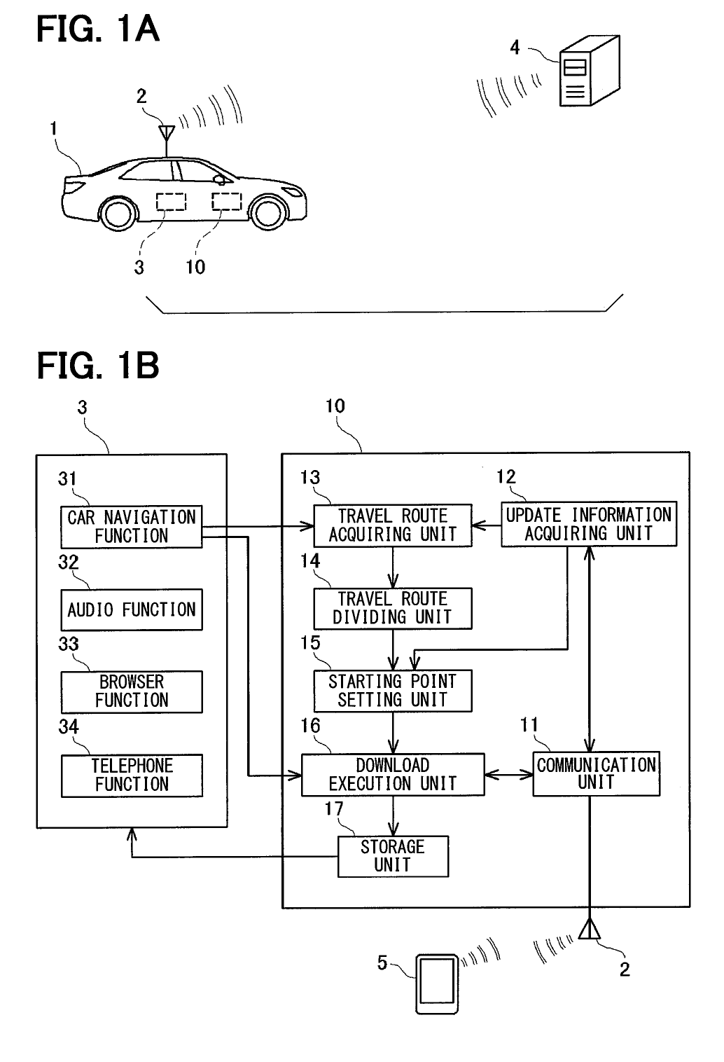

FIGS. 1A and 1B illustrate a general structure of a download device 10 which is mounted on a vehicle 1. As illustrated in FIG. 1A, the vehicle 1 is provided with an antenna 2 in addition to the download device 10 and capable of wirelessly communicating with the outside. The download device 10 downloads various data items used in computer control using wireless communication with the outside. The download device 10 corresponds to the “vehicular download control device” of the present invention.

Further, the vehicle 1 is provided with a vehicular device 3 which integrates functions of various vehicular devices such as a car navigation system (i.e., vehicle Navi) for guiding a travel route and an audio for reproducing music. That is, as illustrated in FIG. 1B, the vehicular device 3 is provided with a car navigation function 31, an audio function 32, a browser function 33 for displaying a web page, and a telephone function 34.

The various functions of the vehicular device 3 operate in accordance with programs corresponding to the respective functions. It is possible to improve the functions or add a new function by updating the programs. Further, it is also possible to improve a function corresponding to a program by updating data that is referred to by the program without updating the program. For example, it is possible to perform route guide also for a newly constructed road by updating map data that is referred to by the program of the car navigation function 31.

In updating various programs used in the vehicular device 3 and data referred to by the programs (hereinbelow, these programs and data are collectively referred to as “software”), data for the update (hereinbelow, referred to as “update data”) is required. In the present embodiment, the download device 10 is used for downloading the update data from a server 4 which is located outside.

As illustrated in FIG. 1B, the download device 10 is provided with a communication unit 11, an update information acquiring unit 12, a travel route acquiring unit 13, a travel route dividing unit 14, a starting point setting unit 15, a download execution unit 16, and a storage unit 17.

These “units” are concepts obtained by classifying the inside of the download device 10 in view of functions and do not represent that the download device 10 is physically divided. Thus, these “units” may be implemented as computer programs executed by a CPU, implemented as an electronic circuit which includes an LSI, a memory, and a timer, or implemented by a combination thereof.

The communication unit 11 is connected to the antenna 2 and wirelessly communicates with the server 4. A mode of the wireless communication may be a mode of directly connecting to and communicating with the server 4 from the antenna 2 or a mode of connecting to a portable terminal 5 held by an occupant of the vehicle 1 and connecting to and communicating with the server 4 through the portable terminal 5.

In this manner, the communication unit 11 is capable of communicating with the server 4 directly and also through another communication device such as the portable terminal 5. Further, the communication device such as the portable terminal 5 generally conforms to a plurality communication standards. Thus, the communication unit 11 has a function of selecting a communication device and a communication standard. The selection may be performed in accordance with setting by an occupant of the vehicle 1 or may be automatically performed according to a predetermined condition. Although, in the present embodiment, wireless communication is performed using the antenna 2 mounted on the vehicle 1, the present disclosure is not limited thereto. An antenna may be built in the download device 10 and used in wireless communication.

The update information acquiring unit 12 acquires update information that notifies a new update of software (that is, a program or data referred to by the program) used by the vehicular device 3. The update information is transmitted by, for example, a manufacturer of the vehicular device 3 through the server 4 and can be acquired by wireless communication between the communication unit 11 and the server 4. It is possible to check whether there is update data that has not yet been applied to the software of the vehicular device 3 on the basis of the acquired update information. Further, it is also possible to acquire information such as the size of the update data on the basis of the update information.

Further, the update information acquiring unit 12 also acquires a required time that is estimated to be required to download update data from the server 4. The required time can be acquired by dividing the size of the update data by a communication speed (the size of date that can be transferred per unit time). The size of the update data can be acquired from the server 4 as described above. On the other hand, the communication speed corresponds to each communication standard. Thus, information indicating which communication device and communication standard are selected by the communication unit 11 for wireless communication with the server 4 is acquired from the communication unit 11.

The update information acquiring unit 12 acquires the required time required to download update data. Thus, the update information acquiring unit 12 corresponds to the “required time acquiring unit” of the present invention.

The travel route acquiring unit 13 acquires a travel route of the vehicle 1 when the update information acquiring unit 12 confirms that there is update data that has not yet been applied to the software of the vehicular device 3. The car navigation function 31 of the vehicular device 3 is capable of determining a travel route to a destination set by the driver. Thus, the travel route of the vehicle 1 is acquired using the car navigation function 31. However, the travel route of the vehicle 1 is not necessarily acquired using the car navigation function 31 of the vehicular device 3. For example, when the driver uses a route guide function of the portable terminal 5, the travel route may be acquired by communication with the portable terminal 5.

The travel route dividing unit 14 divides the travel route acquired by the travel route acquiring unit 13 into a section that is suitable for download (hereinbelow, referred to as a “suitable section”) and a section that is unsuitable for download (hereinbelow, referred to as an “unsuitable section”). Here, “being suitable for download” indicates that there is no possibility (or a possibility that is small enough to ignore) of interruption of download caused by a deterioration in a communication state of wireless communication during the download. Further, “being unsuitable for download” indicates that there is a possibility (or a possibility that is not small enough to ignore) of interruption of download caused by a deterioration in a communication state of wireless communication during the download.

Whether a section is either the suitable section or the unsuitable section can be determined on the basis of an attribute of a point where the travel route passes. That is, when the travel route passes through a point whose attribute is “tunnel”, it is considered that radio waves for wireless communication are difficult to reach inside a tunnel, and such a section can thus be determined to be the unsuitable section. Further, in a street of large buildings, radio waves for wireless communication may be blocked by the buildings, and the wireless communication may be interrupted. Thus, also when the travel route passes through a point whose attribute is “street of large buildings”, such a section can be considered to be the unsuitable section. Hereinbelow, the attribute of points that are unsuitable for download such as “tunnel” and “street of large buildings” is referred to as an “unsuitable attribute”.

On the other hand, when the travel route passes through a point whose attribute is “residential street” or “suburbs”, there is no object that blocks radio waves. Thus, such a section can be considered as the suitable section. Hereinbelow, the attribute of points that are suitable for download such as “residential street” and “suburbs” is referred to as a “suitable attribute”.

Previously giving such information indicating whether an attribute is the unsuitable attribute or the suitable attribute to each point on the map data enables the travel route to be divided into the suitable section and the unsuitable section by reading the attribute given to a point where the travel route passes.

Further, a communication state of wireless communication in each point on a map may be previously checked, and information indicating whether an attribute is the unsuitable attribute or the suitable attribute may be given taking the checked communication state into consideration. For example, when a base station for wireless communication is installed inside a tunnel and radio waves for wireless communication can be stably transmitted and received, the suitable attribute can be given even to a section that passes through the tunnel. On the other hand, when no base station for wireless communication is installed, the unsuitable attribute can be given even to a section where there is no object that blocks radio waves such as the suburbs. Of course, an installation location of a base station for wireless communication may be checked instead of a communication state, and the suitable attribute may be given to a section within a predetermined range from the installation location. Alternatively, a communication state in each point may be recorded every time the vehicle 1 travels, and either the suitable attribute or the unsuitable attribute may be given with reference to the record when the vehicle 1 travels on the same road later.

The starting point setting unit 15 sets a starting point where the download of update data is started in the travel route on the basis of the required time for the download acquired by the update information acquiring unit 12 and a result of the division of the travel route by the travel route dividing unit 14. A method for setting the starting point will be described in detail below.

The download execution unit 16 starts the download of update data by wirelessly communicating with the server 4 through the communication unit 11 when the vehicle 1 has arrived at a download starting point set by the starting point setting unit 15. The download execution unit 16 corresponds to the “download starting unit” of the present invention.

The storage unit 17 temporarily stores the update data downloaded by the download execution unit 16 in a memory.

When the download device 10 has completed the download of the update data in the above manner, the vehicular device 3 can update software by reading the update data stored in the storage unit 17.

### B. Download Process

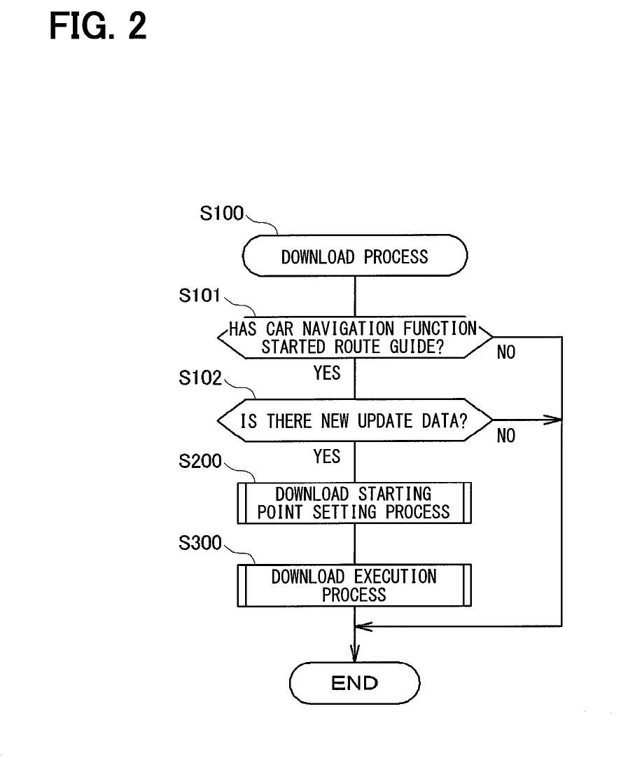

FIG. 2 is a flowchart of a download process (S100) which is executed by the download device 10. The download process (S100) is started when an engine key of the vehicle 1 is turned ON and repeatedly executed at a constant period until the engine key is turned OFF. After the start of the download process (S100), it is first determined whether the car navigation function 31 has started route guide of the vehicle 1 (S101). When the driver has not operated the car navigation function 31 or when the driver has operated the car navigation function 31, but has not set a destination, the car navigation function 31 does not start the route guide (S101: no). Thus, the process is finished.

On the other hand, when the driver has set the destination by operating the car navigation function 31, the car navigation function 31 presents a candidate for a travel route to the destination to the driver. When the driver selects the travel route in response to the presentation, the car navigation function 31 starts route guide (S101: yes).

After the start of the route guide by the car navigation function 31 (S101: yes), it is then determined whether there is new update data (S102). The new update data is update data that has not yet been applied to software mounted on the vehicular device 3. Whether there is new update data can be determined on the basis of update information transmitted from the server 4. When a result of the determination shows that there is no new update data (S102: no), there is no object to be downloaded. Thus, the process is finished. Then, after an elapse of a time of the constant period for executing the download process (S100), the download process is again started, and S101 at the beginning is started.

On the other hand, when there is new update data (S102: yes), a download starting point is set by performing a download starting point setting process (S200), and a download execution process (S300) is started on the basis of a result of the setting.

### C. Download Starting Point Setting Process

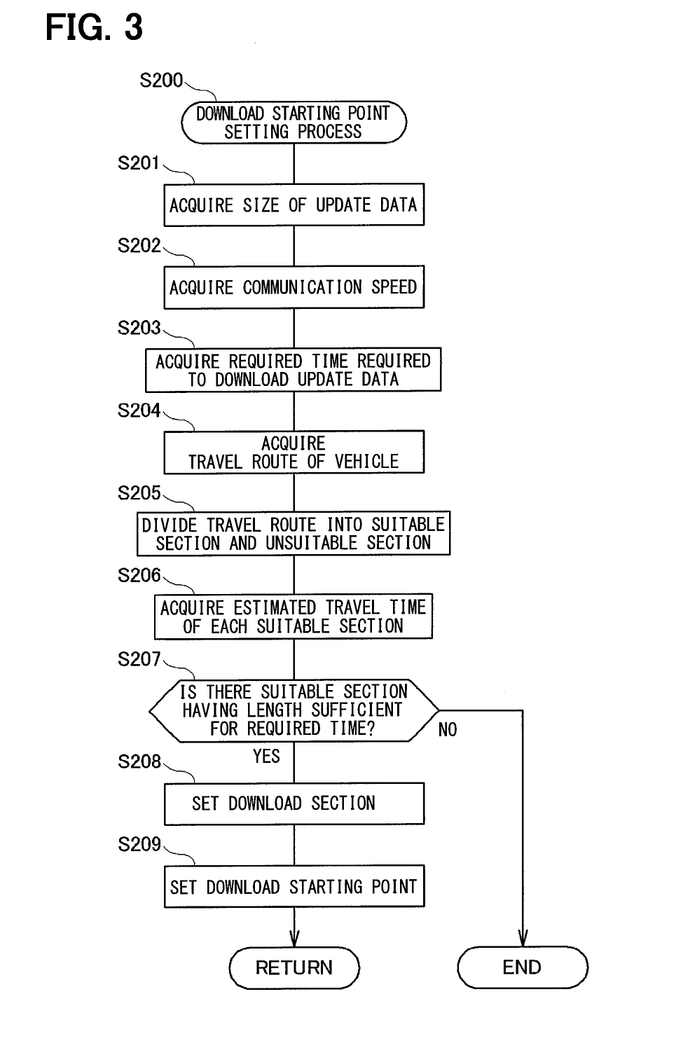

FIG. 3 is a flowchart of the download starting point setting process (S200). In the download starting point setting process (S200), the size of the update data is first acquired (S201). The size of the update data can be acquired on the basis of update information transmitted from the server 4.

Then, a communication speed between the download device 10 and the server 4 is acquired (S202), and a required time that is required to download the update data is acquired (S203). As described above, the required time for the download can be acquired on the basis of the size of the update data and the communication speed.

Next, a travel route of the vehicle 1 is acquired using the car navigation function 31 of the vehicular device 3 (S204). As described above with reference to FIG. 2, the download starting point setting process (S200) is started when the driver of the vehicle 1 has started the route guide using the car navigation function 31 (S101 of FIG. 2: yes). Thus, the travel route of the vehicle 1 can be immediately acquired.

After the acquisition of the travel route of the vehicle 1 (S204), the travel route is divided into the suitable section and the unsuitable section (S205). As described above, the division of whether the suitable section or the unsuitable section is determined by reading an attribute given to a point where the travel route passes from the map data.

Then, after the division of the travel route into the suitable section and the unsuitable section (S204), an estimated travel time of each suitable section is acquired (S205). The estimated travel time indicates a time that is estimated to be required for the vehicle 1 to pass through one suitable section that is present in a continuous state. The estimated travel time is acquired because of the following reasons.

First, a suitable section suitable for download on the travel route can be grasped by the process of S204. While the vehicle 1 is traveling in the suitable section, the download can be executed without a deterioration in a radio wave condition of wireless communication. However, when the length of the suitable section is insufficient for the required time for the download, the download is continued also after the vehicle 1 enters an unsuitable section following the suitable section. After the entry into the unsuitable section, the download may be interrupted due to a deterioration in the radio wave condition of wireless communication. In order to avoid such a situation, a suitable section that has a length sufficient for the required time for the download is previously detected, and the download is completed during a travel in the detected suitable section.

In order to detect the suitable section that has a length sufficient for the required time for the download, the required time for the download and the length of the suitable section may be compared. However, the required time for the download and the length of the suitable section are respectively expressed in time and distance, and thus have different scales. Thus, the required time and the length cannot be compared with each other as they are. Thus, in the present embodiment, the above estimated travel time is acquired to re-express the length of the suitable section in the scale of time.

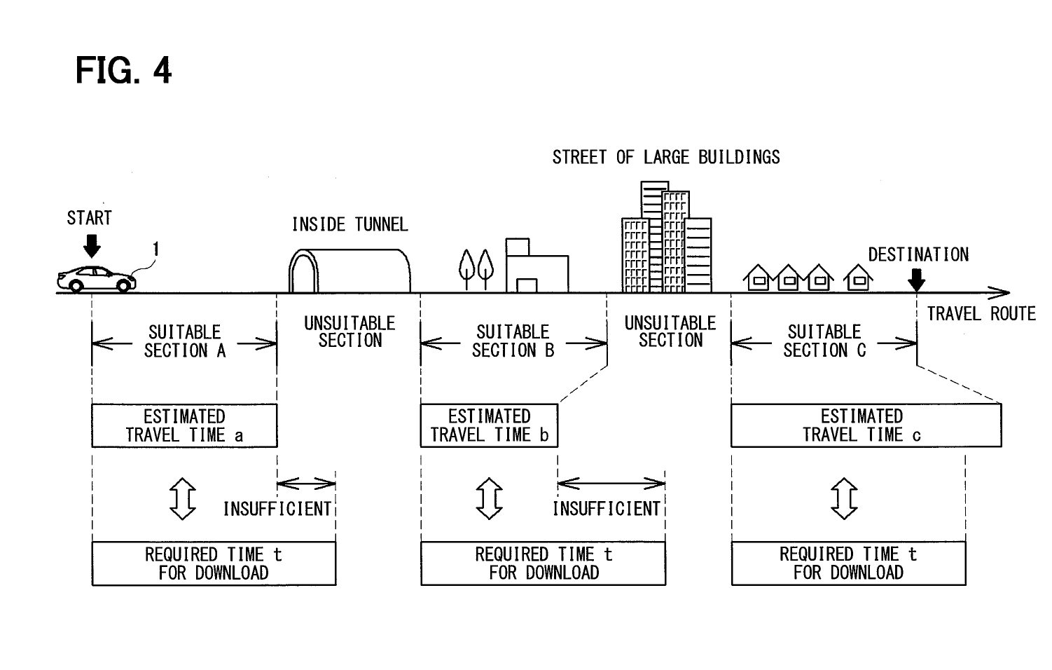

FIG. 4 illustrates, as an example, a state of the comparison between the length of each suitable section and the required time for the download. In the illustrated example, there are a tunnel and a street of large buildings on the travel route of the vehicle 1. A section where the vehicle 1 passes through the tunnel and a section where the vehicle 1 passes through the street of large buildings are defined as unsuitable sections. As a result, sections other than these unsuitable sections (a suitable section A, a suitable section B, and a suitable section C in the illustrated example) are suitable sections.

An estimated travel time of each of the suitable sections is determined by the distance of each of the suitable sections and the travel speed of the vehicle 1. The distance of each of the suitable sections can be easily acquired on the basis of the map data. Further, in the simplest way, a speed limit on the road can substitute for the travel speed of the vehicle 1. However, when the vehicle 1 comes to a stop at a traffic light or a railroad crossing, the vehicle 1 cannot maintain the speed limit. Thus, traffic lights and railroad crossings present on the travel route may be detected, and the travel speed may be estimated lower than the speed limit as the number of traffic lights and railroad crossings increases. Further, also when there is a traffic jam on the travel route, the vehicle 1 cannot maintain the speed limit. Thus, traffic information on the travel route may be acquired, and the travel speed may be estimated lower than the speed limit according to the number of traffic jams and the length of the traffic jam when there is a traffic jam on the travel road.

Of course, circumstances that affect the travel speed of the vehicle 1 are not limited to the above. For example, when the vehicle 1 travels in a residential street or a shopping street, the vehicle 1 may frequently come to a temporal stop due to careful driving. Thus, a condition around a place where the travel route passes may be read from the map data, and the travel speed may be estimated lower than the speed limit when the travel route passes through a residential street or a shopping street.

Further, the car navigation function 31 estimates an arrival time to the destination taking into consideration such various circumstances that affect the travel speed of the vehicle 1. Thus, the estimated travel time of each suitable section can be easily acquired in the following manner by acquiring information relating to the arrival time from the car navigation function 31. First, the car navigation function 31 divides the travel route of the vehicle 1 into sections called links at points such as an intersection, estimates a time required for the vehicle 1 to pass through each of the links, and then adds up these times to estimate the arrival time. Thus, for each suitable section obtained by dividing the travel route in the present embodiment, links included in the suitable section are selected, and times required for the vehicle 1 to pass through the respective selected links are added up. As a result, an estimated travel time of the suitable section can be acquired.

It is assumed that, as a result of the acquisition of the estimated travel time in this manner, an estimated travel time a is acquired for the suitable section A, an estimated travel time b is acquired for the suitable section B, and an estimated travel time c is acquired for the suitable section B as illustrated in FIG. 4. It is possible to check whether each of the suitable sections has a length sufficient for the required time for the download by comparing the estimated travel time of each of the suitable sections with the required time for the download acquired by the above process (S202 of FIG. 3).

In the illustrated example, when the required time for the download is denoted by “t” and compared with each estimated travel time, it can be confirmed that the estimated travel time a is shorter than the required time t for the download, and the suitable section A does not have a length sufficient to execute the download. Similarly, the estimated travel time b is shorter than the required time t for the download. Thus, it can be confirmed that the suitable section B also does not have a sufficient length.

On the other hand, the estimated travel time c is longer than the required time t for the download. Thus, it can be confirmed that the suitable section C has a length sufficient to execute the download.

When the length of each of the suitable sections is checked in the above manner, none of the suitable sections may have a sufficient length in another situation. Thus, in the download starting point setting process of FIG. 3, it is determined whether there is a suitable section having a sufficient length (S207). When a result of the determination shows that there is no suitable section having a sufficient length (S207: no), the download may be interrupted. Thus, the process is finished. In this case, although the update data is not downloaded, the download is executed when the condition is satisfied in the next or subsequent download process (S100).

On the other hand, when there is a suitable section that has a length sufficient for the required time for the download (S207: yes) in the process of S207 of FIG. 3, a suitable section whose estimated travel time is longer than the required time for the download is set as a download section (S208). The download section indicates a section in which the download of update data is set to be executed in the travel route. When there are a plurality of suitable sections having a sufficient length, the download can be executed with sufficient time by setting a suitable section that has the longest estimated travel time as the download section. Alternatively, when it is desired to download the update data as soon as possible, a suitable section that is located closest to the vehicle 1 on the travel route may be set as the download section.

Then, after the setting of the download section (S208), a point where the vehicle 1 first passes in the download section is set as a download starting point (S209). When the required time for the download can be ensured within the download section, the download starting point can also be set at a midpoint in the download section.

After the setting of the download starting point in the above manner (S209), the download starting point setting process (S200) is finished, and a return to the download process of FIG. 2 is made. Then, a download execution process (S300) is started.

### D. Download Execution Process

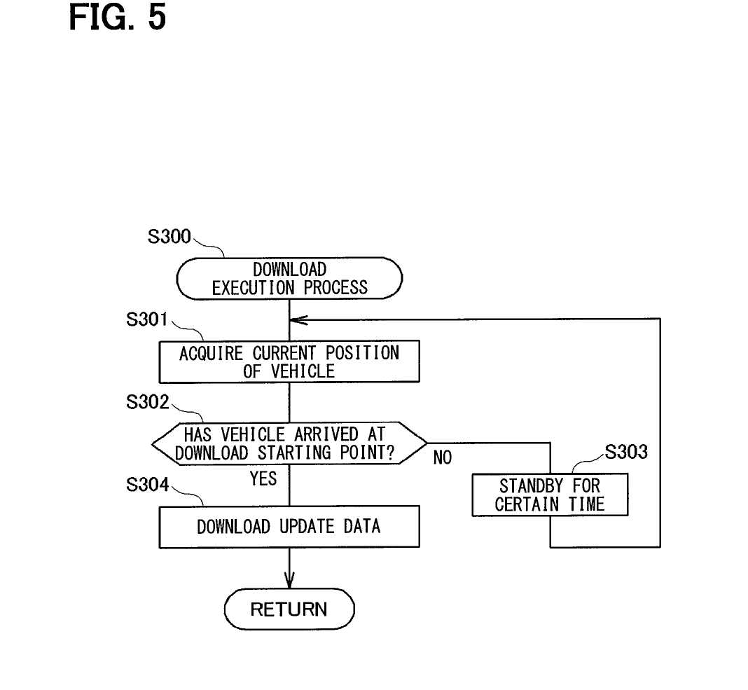

FIG. 5 is a flowchart of the download execution process (S300). In the download execution process (S300), the current position of the vehicle 1 is first acquired (S301). The car navigation function 31 grasps the current position of the vehicle 1 for route guide. Thus, information indicating the grasped current position is acquired.

After the acquisition of the current position of the vehicle 1 (S301), it is determined whether the vehicle 1 has arrived at a download starting point (S302). The download starting point is set at any point on the travel route by the execution of the download starting point setting process (S200 of FIG. 3) described above. The vehicle 1 travels on the travel route. Thus, the current position of the vehicle 1 coincides with the download starting position (S302: yes) in due time by repeating the determination of S302.

Before the vehicle 1 arrives at the download starting point (S302: no), the determination is continuously repeated. However, the determination is kept on standby for a certain time before the determination is performed again (S303). The determination of S302 is a process for grasping an entry of the vehicle 1 into the download section. Thus, it is not necessary to exactly grasp the moment at which the vehicle 1 arrives at the download starting point. Thus, a processing load can be reduced by performing the determination every certain time.

Then, when it is determined that the vehicle 1 has arrived at the download starting point (S302: yes), the update data is downloaded (S304). Then, a return to the download process of FIG. 2 is made, and the process is finished.

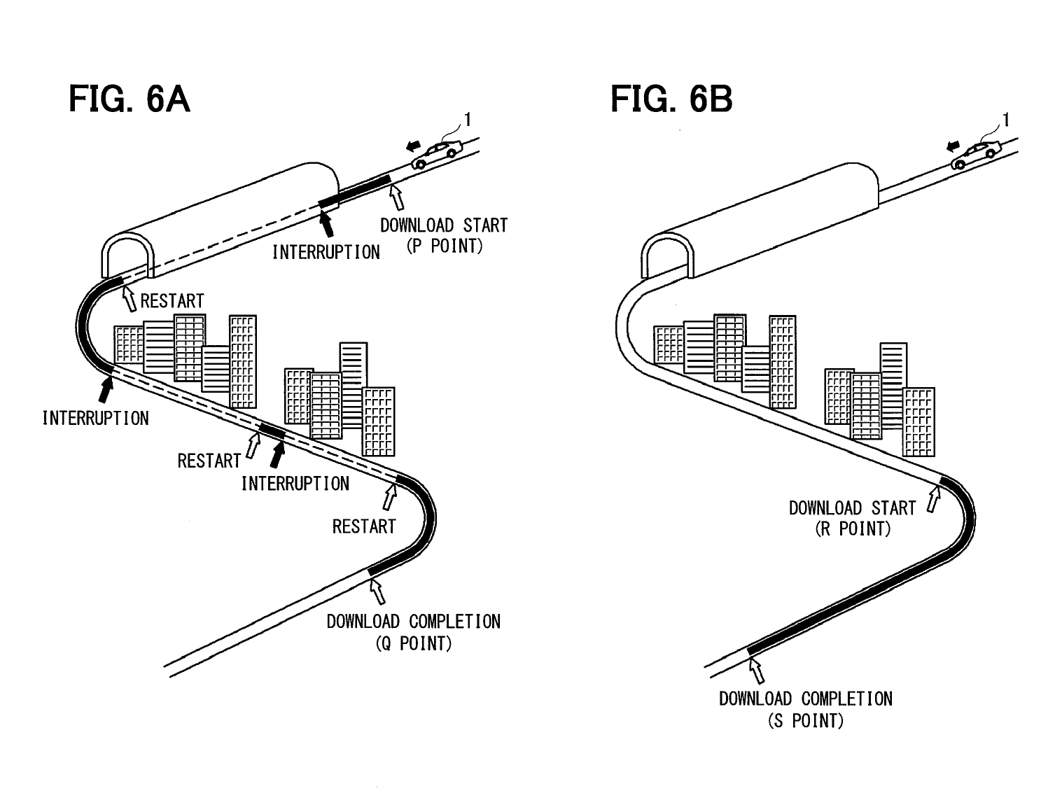

FIGS. 6A and 6B schematically illustrate a state in which update data is downloaded by the download process of the present embodiment. For the purpose of describing effects of the download process of the present embodiment, a case where download is performed by a conventional method will be described first with reference to FIG. 6A.

In a process other than the download process of the present embodiment, when it is determined that there is new update data, download of the new update data is immediately started. In the drawing, a point where the download is started is indicated as a P point. Then, when the vehicle 1 enters a tunnel during the execution of the download, it is not possible to receive radio waves for wireless communication, and the download is interrupted halfway. When the download is forcibly interrupted in this manner, already downloaded pieces of data may entirely become wasted. Further, even when the rest pieces of data can be downloaded later, a piece of data downloaded immediately before the interruption cannot be normally stored and becomes wasted.

Then, when the vehicle 1 comes out of the tunnel, it becomes possible to receive radio waves for wireless communication, and the download is restarted. However, when the vehicle 1 enters a street of large buildings, it becomes impossible to receive radio waves again, and the download is interrupted. In the street of large buildings, radio waves may be received in a gap between buildings. However, such a radio wave state does not last long. Thus, even if the download is restarted, the download is interrupted soon.

Then, the download can be completed after the vehicle 1 comes out of the street of large buildings and it becomes possible to stably receive radio waves. In the drawing, a point where the download is completed is indicated as a Q point. Here, when download is interrupted and then restarted, already downloaded pieces of data have already been stored, and the download may be restarted for the rest pieces of data. However, there is also a case where already stored pieces of data may be destroyed by the interruption of the download, and it is necessary to download all pieces of data again from the beginning. In such a case, a download completion point is farther than the Q point.

In this manner, in a conventional method, it may take a long time to complete download from the start thereof due to the repetition of the interruption and restart of download.

Further, the repetition of the interruption and restart of download increases a wasted communication amount, which may result in an increase in the communication cost. When the download is restarted, another communication is required for setting the restart. This also increases the communication cost.

Further, when download is executed in a bad radio wave state, data may be partially lost. However, the download may be completed with the loss of the data. In this case, such a loss of the data becomes clear when update data is installed later. Thus, the download is performed later again, which requires more time and increases an excessive communication cost.

On the other hand, in the download process of the present embodiment, a section that has an excellent radio wave state of wireless communication and a sufficient length is previously ensured, and download is executed thereafter. Thus, as illustrated in FIG. 6B, the download can be completed with no interruption. No interruption of download eliminates waste in the communication cost, which can reduce the load on a user.

Further, in the conventional case illustrated in FIG. 6A, a section from the start to completion of download is from the P point to the Q point, which is very long. On the other hand, in the case of the present embodiment illustrated in FIG. 6B, a section from the start to completion of download is from an R point to an S point, which is significantly shorter than the conventional section. This also indicates that the time during which the download is executed is short and can obtain the following effects.

First, in implementation of the download device 10 of the present embodiment, hardware resources such as a CPU and a memory may be shared with the vehicular device 3. In this case, while the download device 10 is executing download, hardware resources that can be used in the vehicular device 3 are reduced, which may have an adverse effect such as slowing the operation of the car navigation function 31 or the audio function 32 and may increase the load on a user. In this point, the present embodiment makes it possible to shorten a time during which the operation of the device 3 is affected to reduce the load on a user by shortening the time during which download is executed.

In the above description, in order to detect the suitable section that has a length sufficient for the required time for the download, the estimated travel time of each suitable section is acquired (S206 of FIG. 3), and the required time for the download and the length of each suitable section are compared (FIG. 4). However, the present disclosure is not limited thereto, and the required time for the download may be re-expressed in the scale of distance and compared with the length of each suitable section. In order to re-express the required time for the download in the scale of distance, the travel speed of the vehicle 1 in each suitable section is estimated, and a travel distance when the vehicle 1 travels at the estimated travel speed for the required time for the download is calculated. When a suitable section continuously extends by a distance longer than the travel distance, it can be determined that the suitable section has a length sufficient for the required time for the download.

The travel speed of the vehicle 1 can be estimated assuming that the vehicle 1 travels at a speed limit on the road. In this case, it is desired to correct the travel speed so as to be lower than the speed limit as the number of traffic lights and railroad crossings increases taking into consideration stops at the traffic lights and the railroad crossings. Further, the travel speed of the vehicle 1 may be estimated on the basis of travel data in the past or may be estimated on the basis of traffic jam information if the traffic jam information can be acquired.

### E. Modification

In the above embodiment, when there is no suitable section that has a length sufficient for the required time for the download (S207 of FIG. 3: no), there is a wait for another opportunity having a favorable condition without the execution of download of update data.

However, there may be a situation in which it is necessary to urgently download update data depending on the contents of the update data. In this modification, a case where information indicating the degree of urgency is added to update data will be described. This modification is a modification of the download starting point setting process (S200) described above with reference to FIG. 3. Thus, the above description is used in a point common with the above embodiment, and description will be made focusing on a different point in the modification.

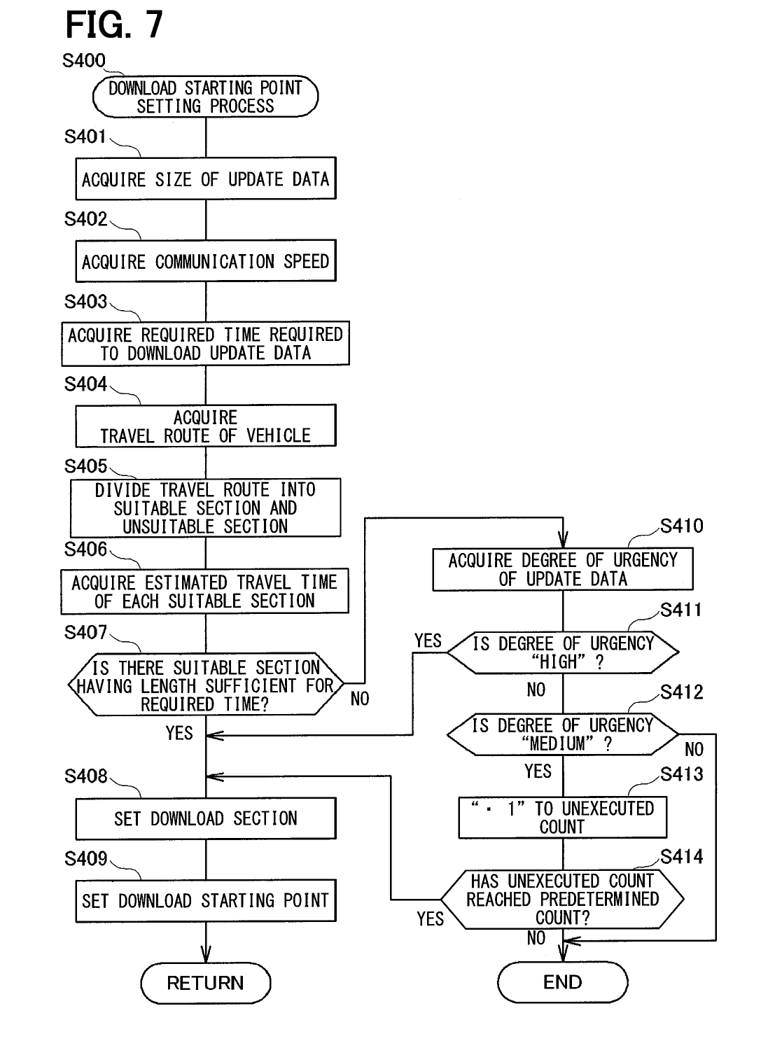

FIG. 7 is a flowchart of a download starting point setting process (S400) according to the modification. In the download starting point setting process (S400), when there is a suitable section that has a length sufficient for the required time for the download, a process similar to the download starting point setting process (S200 of FIG. 3) described above is executed.

That is, first, the size of update data and a communication speed are acquired (S401, S402), and a required time required to download the update data is acquired on the basis of the acquired information (S403).

Next, a travel route of the vehicle 1 is acquired from the car navigation function 31 (S404), and the travel route is divided into a suitable section and an unsuitable section (S405). Then, an estimated travel time of each suitable section is acquired (S406), and it is determined whether there is a suitable section that has a length sufficient for the required time (S407).

When a result of the determination shows that there is a suitable section that has a sufficient length (S407: yes), the suitable section is set as the download section (S408), and a point where the vehicle 1 first passes in the download section is set as a download starting point (S409).

On the other hand, when there is no suitable section having a sufficient length in the process of S407 (S407: no), the following process is executed.

First, the degree of urgency of the update data is acquired (S410). As described in the above embodiment, update information notifying a new update is transmitted from the server 4, and the update information includes the size of the update data. In this modification, information indicating the degree of urgency of the update data is added to the update information. The degree of urgency is set to any of three stages of values including “high”, “medium”, and “low”. Then, after the acquisition of the degree of urgency of the update data (S410), it is determined whether the acquired degree of urgency is “high” (S411).

The acquisition of the degree of urgency and the determination of a value of the degree of urgency are executed by the update information acquiring unit 12 (refer to FIGS. 1A and 1B) provided in the download device 10.

When a result of the determination of whether the acquired degree of urgency is “high” (S411) shows that the degree of urgency is “high” (S411: yes), the download section is set (S408). It is to be noted that processes after S410 are executed on the condition that there is no suitable section that has a length sufficient for the required time for the download in the previous process of S407 (S407: no). Thus, in the process of S408 executed after the determination of “yes” in S411, it is not possible to set a suitable section having a sufficient length as the download section. Therefore, here, a suitable section having the longest estimated travel time is set as the download section among suitable sections whose estimated travel times are acquired in the process of S406.

In this case, there is a possibility that the download cannot be completed during a travel in the suitable section, and the vehicle 1 enters the unsuitable section with the download uncompleted. However, entering the unsuitable section does not necessarily result in an immediate stop of the reception of radio waves for wireless communication. Further, even when the download is interrupted by a stop of the reception of radio waves for wireless communication in the unsuitable section, the download can be completed as early as possible by restarting the download of the rest pieces of data except already downloaded pieces of data after the interruption. When the degree of urgency of the update data is “high” (S411: yes), the risk of the interruption of the download is accepted on the basis of the above idea, and the download section is set attaching importance to a speedy download of the update data (S408). Then, a point where the vehicle 1 first passes in the set download section is set as the download starting point (S409). Then, in a manner similar to that of the above embodiment, a return to the download process of FIG. 2 is made, and the download execution process (S300 of FIG. 5) is executed thereafter.

When the degree of urgency is not “high” in the determination of S411 of FIG. 7 (S411: no), it is then determined whether the degree of urgency is “medium” (S412). When a result of the determination shows that the degree of urgency is not “medium” (S412: no), the degree of urgency is neither “high” nor “medium” in the three stages of values including “high”, “medium”, and “low”. Thus, the degree of urgency is “low”. When the degree of urgency is low, it is not necessary to execute the download in a case where there is a possibility of the interruption of the download. Thus, in a manner similar to that of the above embodiment, the process is finished without executing the download of the update data.

On the other hand, when it is determined that the degree of urgency is “medium” in the process of S412 (S412: yes), an unexecuted count is counted by “·1” (S413). The unexecuted count indicates information obtained by counting the number of unexecutions of download for update data whose degree of urgency is “medium”.

Then, it is determined whether the unexecuted count has reached a predetermined number (S414). When the unexecuted count is less than the predetermined number (S414: no), the process is finished without executing the download of the update data in a manner similar to the case where the degree of urgency is “low”.

The process of counting the unexecuted count and the determination of whether the unexecuted count has reached the predetermined number are executed by the update information acquiring unit 12 (refer to FIGS. 1A and 1B) provided in the download device 10.

When the unexecuted count has reached the predetermined time in the determination of S414 (S414: yes), the download section is set even when the suitable section having a sufficient length cannot be ensured (S408) in a manner similar to the case where the degree of urgency is “high”. This makes it possible to avoid a situation in which a period during which the download is not executed becomes long while refraining from the execution of the download as much as possible when there is a possibility of the interruption of the download for update data whose degree of urgency is “medium”. Thus, the predetermined number for the unexecuted count is determined on the basis of how long period in which the download is not executed can be allowed.

As described above, according to the modification, it is possible to promptly download update data while preventing the download from being interrupted in a manner similar to the above embodiment and accepting the risk of the interruption of the download in the case of emergency.

In the above description, the degree of urgency is set using the three stages of values including “high”, “medium”, and “low”. Alternatively, any of the values may be eliminated, and the degree of urgency may be set using two stages of values. For example, when setting of the degree of urgency “medium” is eliminated, it is not necessary to use the unexecuted count (refer to S413 of FIG. 7).

On the other hand, the degree of urgency of four or more stages in total may be set by further dividing a setting corresponding to the degree of urgency “medium” into two stages or more. In this case, a plurality of settings corresponding to the degree of urgency “medium” may have different predetermined numbers for the unexecuted count (refer to S414).

In the above description, when the degree of urgency is “high” (S411: yes), the suitable section having the longest estimated travel time is set as the download section even when there is no suitable section that has a length sufficient for the required time for the download. However, the download section is not necessarily set to one suitable section, and may be set to a plurality of suitable sections in a divided manner. This eliminates a forcible interruption of download by the entry of the vehicle 1 into the unsuitable section during the execution of the download. Also when the download section is set in a divided manner, the download is suspended if the download is not completed within one suitable section. However, this suspension is not a forcible interruption. Thus, already downloaded pieces of data can be normally stored.

When the download section is set in a divided manner, each suitable section set as the download section is desirably selected from suitable sections having a long estimated travel time. This reduces the number of download interruptions and reduces a communication amount for setting a restart that is required in restarting download.

The embodiment of the present invention has been described above. However, the present invention is not limited to the above embodiment and can be performed in more various modes within the scope of the invention.

For example, although, in the above embodiment, downloading update data of software mounted on the vehicular device 3 has been described, the present invention is not limited thereto. Data of other contents can also be downloaded by performing the present invention in the same manner.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed:

1. A vehicular download control device that is mounted on a vehicle having a function of acquiring a current position and a function of acquiring a travel route to a set destination, and controls an operation of download of data from an outside of the vehicle, the vehicular download control device comprising:
a travel route acquiring unit that acquires the travel route of the vehicle;
a travel route dividing unit that divides the travel route into an unsuitable section unsuitable for the download and a suitable section suitable for the download based on an attribute of a point where the travel route passes;
a required time acquiring unit that acquires a required time required for the download of the data;
a starting point setting unit that detects a suitable section having a length sufficient to complete the download within a single suitable section based on the required time of the download, and sets a starting point of the download of the data on the travel route within the single suitable section; and
a download starting unit that detects an arrival of the vehicle at the starting point and starts the download of the data.

2. The vehicular download control device according to claim 1, wherein:
the travel route acquiring unit acquires the travel route and the attribute of the point where the travel route passes; and
the travel route dividing unit preliminarily stores at least one of an unsuitable attribute unsuitable for the download and a suitable attribute suitable for the download, and divides the travel route into the unsuitable section and the suitable section based on whether the attribute of the point where the travel route passes corresponds to the unsuitable attribute or the suitable attribute.

3. The vehicular download control device according to claim 1, wherein:
the required time acquiring unit acquires a data size of the data and calculates the required time based on the data size and a communication speed of the download of the data.

4. (canceled)

5. The vehicular download control device according to claim 1, wherein:
the starting point setting unit:
acquires a travel distance when the vehicle travels at a travel speed, which is estimated based on a speed limit on a road, for the required time of the download;
detects the suitable section that has the length longer than the travel distance; and
sets the starting point of the download so as to complete the download within the single suitable section.

6. The vehicular download control device according to claim 1, wherein:
the starting point setting unit:
detects the suitable section having an estimated travel time required for the vehicle to pass through the single suitable section, the estimated travel time being longer than the required time of the download; and
sets the starting point of the download so as to complete the download within the single suitable section.

7. The vehicular download control device according to claim 1, wherein:
the required time acquiring unit acquires the required time of the download and a degree of urgency of the download; and
the starting point setting unit sets the starting point of the download within a suitable section disposed on the travel route in a case where the degree of urgency of the download is equal to or larger than a predetermined value even when the starting point setting unit does not detect the single suitable section to complete the download within the single suitable section.

8. A download control method, for a vehicle having a function of acquiring a current position and a function of acquiring a travel route to a set destination, for controlling an operation of download of data from an outside of the vehicle, the download control method comprising:
acquiring the travel route of the vehicle;
dividing the travel route into an unsuitable section unsuitable for the download and a suitable section suitable for the download based on an attribute of a point where the travel route passes;
acquiring a required time required for the download of the data;
detecting a suitable section having a length sufficient to complete the download within a single suitable section based on the required time of the download, and setting a starting point of the download of the data on the travel route within the single suitable section; and
detecting an arrival of the vehicle at the starting point, and starting the download of the data.
